(19) United States
(12) Patent Application Publication
(10) Pub. No.: US 2003/0136904 A1
(43) Pub. Date: Jul. 24, 2003

(54) Liquid chromatograph mass spectrometer

(75) Inventor: Kazuo Mukaibatake, Kyoto-shi (JP)

Correspondence Address: KANESAKA AND TAKEUCHI, Suite 2, 1423 Powhatan Street, Alexandria, VA, 22314, US

(73) Assignee: SHIMADZU CORPORATION

(21) Appl. No.: 10/330,064

(22) Filed: Dec. 30, 2002

(30) Foreign Application Priority Data
Jan. 23, 2002 (JP) 2002-013635

(51) Int. Cl. H01J 49/04

(52) U.S. Cl. 250/288

(57) ABSTRACT

A liquid chromatograph mass spectrometer is provided with an interface portion between a liquid chromatograph portion and a mass spectrometry portion. In the interface portion, an ionizing device is provided to ionize a liquid sample sent from the liquid chromatograph portion. Also, a desolvating device is provided to remove a solvent from the produced ions or charged droplets by the ionizing device. Then, the sample is introduced into the mass spectrometry portion. The interface portion has a plurality of ionizing devices for ionizing the liquid sample by different methods.

### BACKGROUND OF THE INVENTION AND RELATED ART STATEMENT

The invention relates to a liquid chromatograph mass spectrometer (hereinafter referred to as “LC/MS”), and more particularly, to an interface disposed between a liquid chromatograph portion and a mass spectrometry portion of the LC/MS.

In an analytical method of the LC/MS, a component separated at the liquid chromatograph portion is ionized under the atmospheric pressure, and introduced into the mass spectrometry portion. In this case, it is necessary to provide an interface for ionizing the component separated through a column in the liquid chromatograph portion. The interface generally used in the LC/MS includes an electrospray ionization method (hereinafter referred to as “ESI method”) and an atmospheric pressure chemical ionizing method (hereinafter referred to as “APCI method”).

In the ESI method, a liquid sample is introduced to a tip of a thin nozzle, and a high voltage is applied to the tip of the nozzle. As a result, a strong unequal electric field is formed at the tip of the nozzle, and the liquid sample is nebulized as charged droplets by the strong electric field. Further, the droplets are divided by Coulomb force of ions in the droplets, thereby being ionized. On the other hand, in the APCI method, a gas flow in a nebulizer forces the liquid sample to be nebulized. Then, the nebulized liquid sample is heated to evaporate solvent in the droplets. Thereafter, buffer ions are produced by the corona discharge to ionize the sample (chemical ionization).

FIG. 5 is a schematic view showing a general structure of a conventional LC/MS. A reference numeral 31 represents a liquid chromatograph portion, and a reference numeral 40 represents a mass spectrometry portion. A reference numeral 50 represents an interface portion, which includes an electrospray ionizing portion 52 using the ESI method. Also, a heating mechanism (not shown) is provided in thin pipes 54 disposed next to the electrospray ionizing portion 52 for functioning as a desolvation device to accelerate desolvation of the charged droplets produced at the electrospray ionizing portion 52.

In the liquid chromatograph portion 31, the sample is injected through a sample introduction portion 35. Then, a liquid supply pump 34 supplies a mobile phase 33 to carry the sample to a column 36, and the sample is separated there. An electrospray probe 53 includes a pipe through which the liquid sample is supplied from the liquid chromatograph portion 31. A front end of the pipe opposite to the thin pipes 54 is formed in a needle shape, so that the liquid passing through the pipe is sprayed through a nozzle portion of the needle shape front end. Then, a high voltage generating circuit (not shown) applies a high voltage in the order of several KV to the electrospray probe 53. With this structure, the liquid sample sent from the liquid chromatograph portion 31 is drawn in a spray shape by a strong electric field formed near the nozzle of the front end of the needle. At this time, a part of the liquid sample becomes an ion and a charged droplet, and enters into the thin pipes 54.

A heater in the thin pipes 54 heats the charged droplets to evaporate a solvent. The droplets are micronized further through collisions with other particles, thereby accelerating ionization thereof. The ions thus produced are drawn out from the thin pipes 54 and sent to the mass spectrometry portion 40.

While passing through the thin pipes 54 as described above, the desolvation and ionization of the liquid sample are accelerated, and the ions thereof are introduced into the mass spectrometry portion 40. The mass spectrometry portion 40 is held in a reduced pressure state by a rotary pump 44, and is held in a further reduced pressure state by turbo molecular pumps 45, 46. The ionized sample introduced into the reduced pressure state of the mass spectrometry portion 40 as described above is converged by a lens effect of a convergent lens 42 and a quadruple pole rod 43, and then the sample is analyzed.

On the other hand, when the APCI method is used for the ionization, an atmospheric pressure chemical ionizing portion 60 shown in FIG. 6 is attached instead of the electrospray ionizing portion 52 shown in FIG. 5. More specifically, the atmospheric pressure chemical ionizing portion 60 includes a pipe through which the liquid sample passes; a probe 62 with a front end formed in a needle shape; an atomizing chamber 61 disposed to surround the needle portion of the probe 62; and a discharge electrode 63 disposed in front of an opening of the atomizing chamber 61. A heater (not shown) heats the atomizing chamber 61, and also, a voltage in several KV is applied to the discharge electrode 63. Thus, the liquid sample sent from the liquid chromatograph portion 31 is sprayed into the atomizing chamber 61 through a nozzle at the front end of the needle of the probe 62 by an atomizing gas from a gas line connected separately to the probe, and the solvent is heated and removed by the heater. Then, the liquid sample is ionized through contact with the buffer ions produced at the discharge electrode. While the desolvation and the ionization of the ions and charged droplets thus produced are accelerated in the same manner as in the above-described ESI method, through the heated thin pipes 54, the sample is sent to the mass spectrometry portion 40.

As described above, in both ESI method and the APCI method, different ionizing portions are used. Thus, when the analysis is carried out, the ionizing portion needs to be changed according to the method to be used. Depending on a type of sample, either of the ESI method and the APCI method is suitable for analyzing the sample. Therefore, it is necessary to carry out the analysis using the ESI method or the APCI method separately. For example, the APCI method is suitable for analyzing a sample with a low polarity, and the ESI method is suitable for a sample with a high polarity. Therefore, when a sample includes a component suitable for the ESI method and another component suitable for the APCI method, the analysis needs to be carried out twice using the ionizing portion for the ESI method and the ionizing portion for the APCI method. Thus, it takes long time and high cost for the analysis. Also, when an unknown sample is analyzed, since it is not known which ionizing method should be used, both the ESI and APCI methods have to be carried out. Further, switching of the ionizing portions also takes time and cost.

In view of the above problems, the present invention has been made and an object of the invention is to provide a liquid chromatograph mass spectrometer (LC/MS), wherein an analysis can be carried out easily in a short time without reviewing an ionizing method with respect to an unknown sample and without knowing characteristics of a sample to be analyzed. In the invention, one analysis is sufficient even for a sample including mixed components suitable for different ionizing methods, resulting in a shorter time at a lower cost.

Further objects and advantages of the invention will be apparent from the following description of the invention.

### SUMMARY OF THE INVENTION

In order to solve the above problems, a liquid chromatograph mass spectrometer (LC/MS) of the present invention is provided with an interface portion between a liquid chromatograph portion and a mass spectrometry portion. In the interface portion, an ionizing device is provided for ionizing a liquid sample sent from the liquid chromatograph portion. Also, a desolvating device is provided for removing a solvent from the produced ions or charged droplets by the ionizing device. Then, the sample is introduced into the mass spectrometry portion. According to the present invention, the interface portion has a plurality of ionizing devices for ionizing the liquid sample.

The interface portion has the plurality of the ionizing devices so that both an electrospray ionization method (hereinafter referred to as “ESI method”) and an atmospheric pressure chemical ionizing method (hereinafter referred to as “APCI method”) can be applied. Thus, the sample can be ionized in one analysis while switching between the ESI method and the APCI method. Also, in a case the switching is not necessary, it is possible to obtain ions produced by both the ESI method and the APCI method at the same time. Thus, without reviewing an optimum ionizing method for the sample or without knowing characteristics of the sample to be analyzed, the analysis can be easily carried out in a short time.

### BRIEF DESCRIPTION OF THE DRAWINGS

FIG. 1 is a schematic view showing an embodiment of a liquid chromatograph mass spectrometer (LC/MS) according to the present invention;

FIG. 2 is a graph showing a result obtained by the LC/MS according to the invention;

FIG. 3(A) is a graph showing a result obtained by a conventional LC/MS using an electrospray ionization (ESI) method;

FIG. 3(B) is a graph showing a result obtained by a conventional LC/MS using an atmospheric pressure chemical ionizing (APCI) method;

FIG. 4 is a graph showing a result obtained by the LC/MS of the invention;

FIG. 5 is a schematic view showing an interface portion of a conventional LC/MS using the ESI method; and

FIG. 6 is a schematic view showing an interface portion of a conventional LC/MS using the APCI method.

### DETAILED DESCRIPTION OF PREFERRED EMBODIMENTS

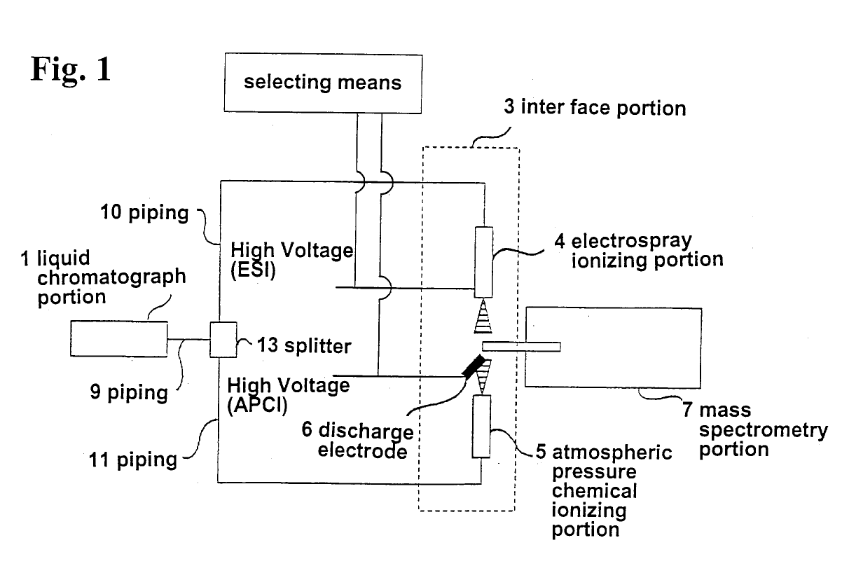

Hereunder, an embodiment according to the present invention will be explained with reference to the accompanying drawings. FIG. 1 is a schematic view for showing a liquid chromatograph mass spectrometer (LC/MS) of an embodiment according to the invention. The LC/MS includes a liquid chromatograph portion 1, an interface portion 3, a mass spectrometry portion 7, pipings 9, 10, 11, and a splitter 13. The interface portion 3 is formed of an electrospray ionizing portion 4 and an atmospheric pressure chemical ionizing portion 5 in which a discharge electrode 6 is disposed.

A sample eluted from the liquid chromatograph portion 1 is divided at the splitter 13 after passing through the piping 9, and introduced to the electrospray ionizing portion 4 and the atmospheric pressure chemical ionizing portion 5 through the pipings 10, 11. At this time, the splitter 13 adjusts a quantity of the liquid introduced into the electrospray ionizing portion 4 and the atmospheric pressure chemical ionizing portion 5. The liquid sample introduced into the electrospray ionizing portion 4 and the atmospheric pressure chemical ionizing portion 5 is ionized when a high voltage is applied to the atmospheric pressure chemical ionizing portion 5 and the discharge electrode 6 disposed at the electrospray ionizing portion 4, and then led to the mass spectrometry portion 7.

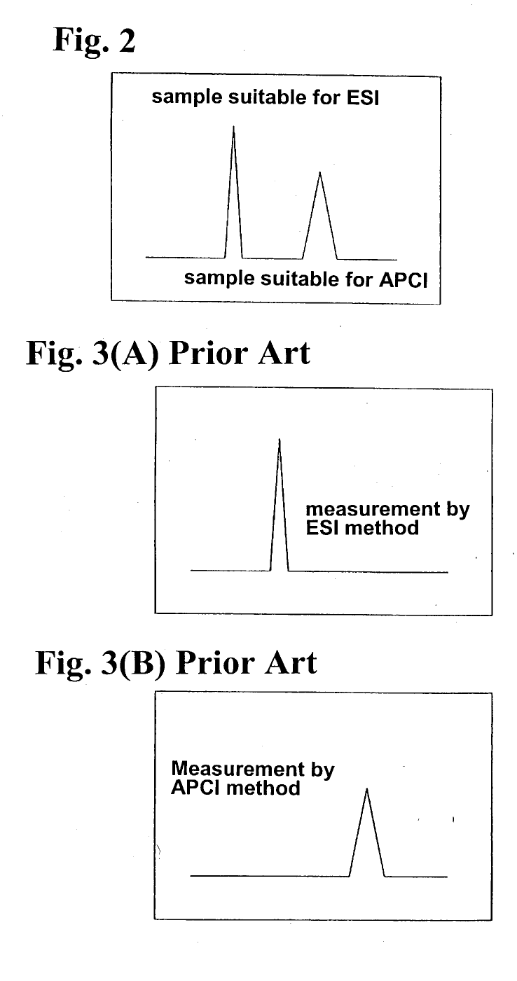

When an analysis is carried out under a state where the high voltage is applied simultaneously to the discharge electrodes 6 of the electrospray ionizing portion 4 and the atmospheric pressure chemical ionizing portion 5, it is possible to obtain a result combined by the ESI method and APCI method. The result thus measured is shown in FIG. 2. Also, the results obtained separately by the ESI and APCI methods are shown in FIGS. 3(A) and 3(B), respectively. In the conventional method as shown in FIG. 3(A), the sample suitable for the ESI method can be detected. However, the sample suitable for the APCI method can not be detected. In the same manner, as shown in FIG. 3(B), while the sample suitable for the APCI method can be detected, the sample suitable for the ESI method can not be detected. Therefore, according to the conventional method, the measurement needs to be done twice. According to the present invention, both samples suitable for the ESI method and the APCI method can be detected, so that the analysis of the sample can be carried just once.

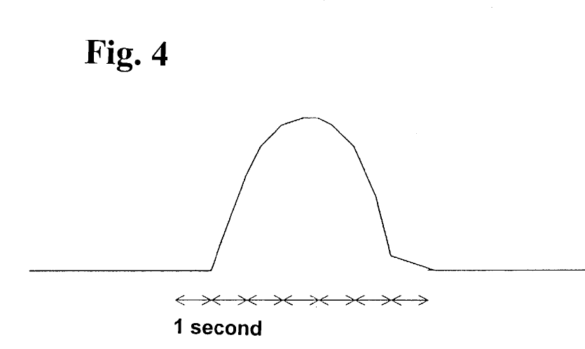

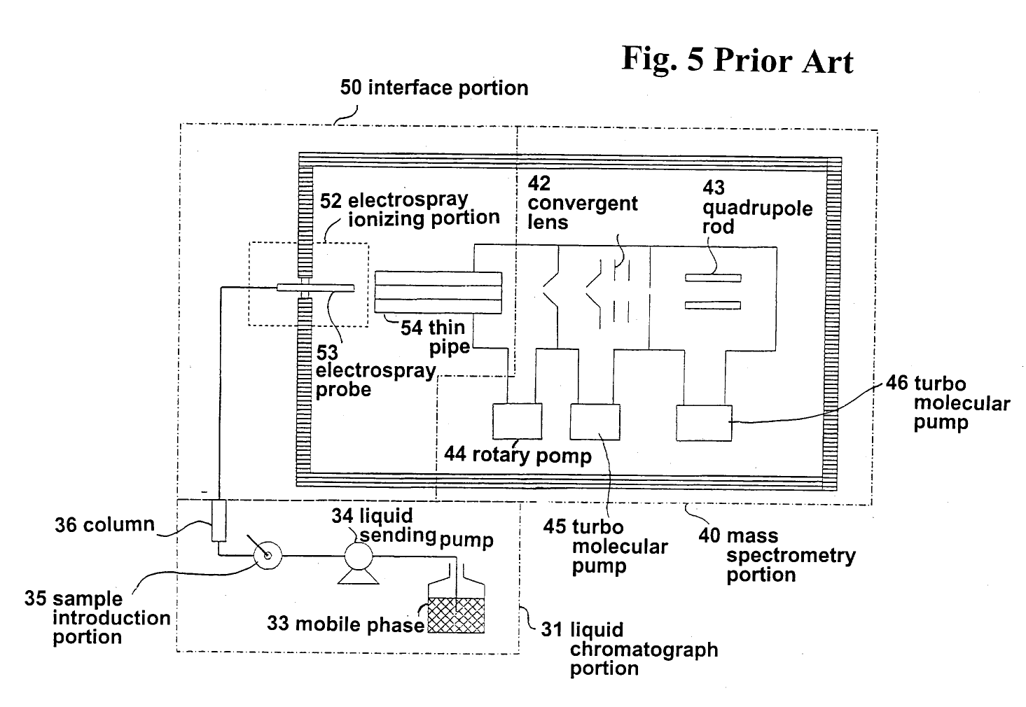

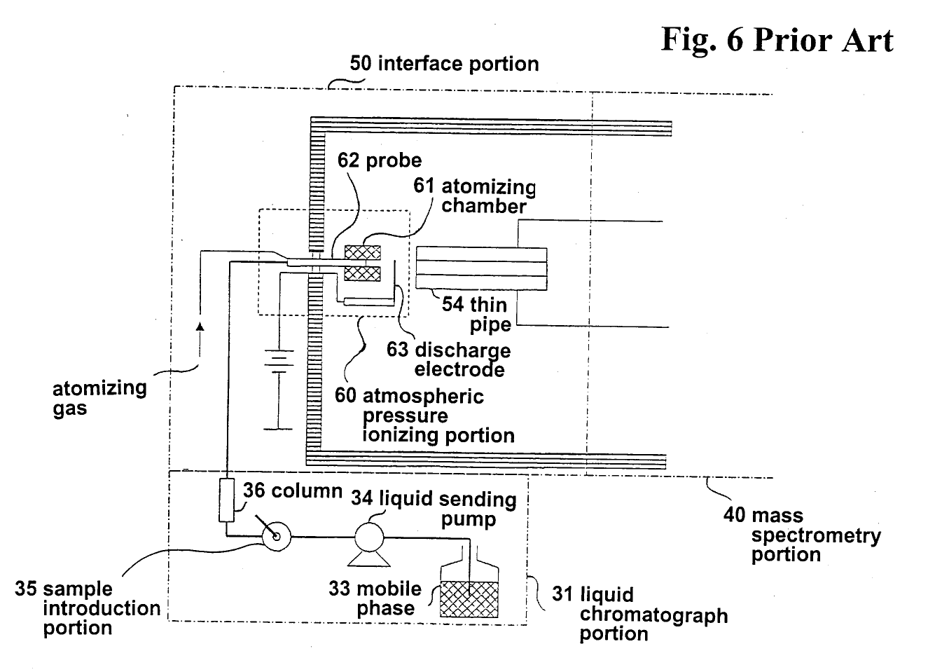

By switching the high voltage applied between the electro spray ionizing portion 4 and the atmospheric pressure chemical ionizing portion 5, it is possible to obtain a result by the ESI method alone, a result by the APCI method alone, or a result by both the ESI method and the APCI method in one measurement. These results may be processed in synchronism with the switching of the high voltages. In other words, the ions obtained during a time when the high voltage is applied to a specific ionizing method can be processed as a result obtained by the specific ionizing method. Therefore, it is possible to extract the ions corresponding only to the specific ionizing method. For example, the analysis may be carried out while switching between the ESI method, the APCI method and both of the ESI and APCI methods every second. Accordingly, a result can be continuously obtained by the respective ionizing methods, as shown in FIG. 4.

Hereinabove, the embodiment according to the present invention has been explained. However, the present invention is not limited to the above embodiment and various changes can be made as long as they are within a scope of claims. For example, as the ionizing method, while the ESI method and the APCI method are used, the ionizing method is not limited thereto. Various ionizing methods, such as a fast atom bombardment method (FAB method), can also be employed. Also, when the liquid sample is introduced to the electrospray ionizing portion 4 and the atmospheric pressure chemical ionizing portion 5, a quantity of the liquid sample may be adjusted by disposing a resisting pipe to the pipings 10, 11, instead of the splitter 13 in the present embodiment.

According to the present invention, since the plurality of the ionizing devices is provided in the interface portion, the analysis can be carried out in a short time without optimizing the ionizing method with respect to a sample.

While the invention has been explained with reference to the specific embodiments of the invention, the explanation is illustrative and the invention is limited only by the appended claims.

What is claimed is:

1. A liquid chromatograph mass spectrometer having a liquid chromatograph portion and a mass spectrometry portion, comprising:
an interface portion provided between the liquid chromatograph portion and the mass spectrometry portion, said interface portion having a plurality of ionizing devices different from each other for ionizing a sample sent from the liquid chromatograph portion upon application of a voltage, and a desolvating device for desolvating the sample before introducing the sample to the mass spectrometry portion.

2. A liquid chromatograph mass spectrometer according to claim 1, further comprising selecting means electrically connected to the ionizing devices for selectively applying the voltage to at least one of the ionizing devices for actuating the same for measurement.

3. A liquid chromatograph mass spectrometer according to claim 1, further comprising a splitter disposed between the liquid chromatograph portion and the ionizing devices for dividing the sample supplied from the liquid chromatograph portion, and for introducing the sample to each of the ionizing devices.

4. A liquid chromatograph mass spectrometer according to claim 3, wherein said plurality of ionizing devices includes electro spray ionizing portion and atmospheric pressure chemical ionizing portion.
